(19) United States
(12) Patent Application Publication
(10) Pub. No.: US 2006/0057394 A1
(43) Pub. Date: Mar. 16, 2006

(54) System and method for coating a substrate

(75) Inventor: Michael S. Cork, Richardson, TX (US)

Correspondence Address: SCOTT T. GRIGGS, 1717 MAIN STREET, SUITE 3400, DALLAS, TX, 75201, US

(73) Assignee: Specialty Products, Inc.

(21) Appl. No.: 10/980,457

(22) Filed: Nov. 3, 2004

Related U.S. Application Data
(60) Provisional application No. 60/611,124, filed on Sep. 15, 2004.

(51) Int. Cl. B32B 27/40

(52) U.S. Cl. 428/423.1

(57) ABSTRACT

A system and method are disclosed that provide for coating a substrate. In one embodiment, the coating system includes a polyurethane-polyurea polymer disposed on a surface of the substrate. The polyurethane-polyurea polymer has a mercaptan content of about 0.5% to about 5.0% and is the reaction product of a polyisocyanate prepolymer component and an isocyanate-reactive component.

This application claims priority from co-pending U.S. Patent Application No. 60/611,124, entitled “Polyurethane-polyurea Polymer” and filed on Sep. 15, 2004, in the name of Michael S. Cork. This application discloses subject matter related to the subject matter disclosed in the following commonly owned, co-pending patent applications: (1) “Isocyanate-reactive Component for Preparing a Polyurethane-polyurea Polymer,” filed on Nov. 3, 2004, application Ser. No. ______ (Attorney Docket No. 1006.1001), in the name of Michael S. Cork; and (2) “Polyisocyanate Prepolymer Component for Preparing a Polyurethane-polyurea Polymer,” filed on Nov. 3, 2004, application Ser. No. ______ (Attorney Docket No. 1006.1002), in the name of Michael S. Cork; both of which are hereby incorporated by reference for all purposes.

### TECHNICAL FIELD OF THE INVENTION

This invention relates, in general, to polyurethane-polyurea polymers and, in particular, to a system and method for coating a substrate that utilizes a high-pressure impingement mixing reaction to synthesize a polyurethane-polyurea polymer coating.

### BACKGROUND OF THE INVENTION

Polyurethanes and related polyureas are used in a wide variety of applications, including fibers (particularly the elastic type), adhesives, coatings, elastomers, and flexible and rigid foams. A number of methods have been employed to prepare polyurethanes and polyureas. For example, in industrial applications, polyurethane-polyurea polymers are typically synthesized by the condensation reaction of a polyisocyanate, such as diphenylmethane diisocyanate, and a resin that includes a hydroxyl-containing material. Resins may also include linear polyesters, polyethers containing hydroxyl groups, amine-substituted aromatics, and aliphatic amines. The resulting polyurethane-polyurea polymer provides resistance to abrasion, weathering, and organic solvents and may be utilized in a variety of industrial applications as a sealant, caulking agent, or lining, for example.

It has been found, however, that the existing polyurethane-polyurea polymers are not necessarily successful in aggressive environments. The existing polyurethane-polyurea polymers exhibit insufficient chemical and/or permeability resistance when placed into prolonged contact with organic reagents such as fuels and organic solvents. Accordingly, further improvements are warranted in the preparation of polyurethane-polyurea polymers.

### SUMMARY OF THE INVENTION

A system and method are disclosed that provide for coating a substrate. The coating includes a polyurethane-polyurea polymer having mercaptan functional moieties which enable the polyurethane-polyurea polymer to perform well in all environments and protect the substrate. In particular, the polyurethane-polyurea polymer prepared according to the teachings presented herein exhibits improved chemical resistance and/or impermeability in the presence of organic reagents.

In one embodiment, the coating system includes a polyurethane-polyurea polymer disposed on a surface of the substrate. The polyurethane-polyurea polymer has a mercaptan content of about 0.5% to about 5.0% and is the reaction product of a polyisocyanate prepolymer component and an isocyanate-reactive component.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 depicts a schematic diagram of one embodiment of a system for coating a substrate;

FIG. 2 depicts a flow chart of one embodiment of a method for coating a substrate;

FIG. 3 depicts a schematic diagram of one embodiment of a system for fabricating a polymer; and

FIG. 4 depicts a schematic diagram of another embodiment of a system for fabricating a polymer.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

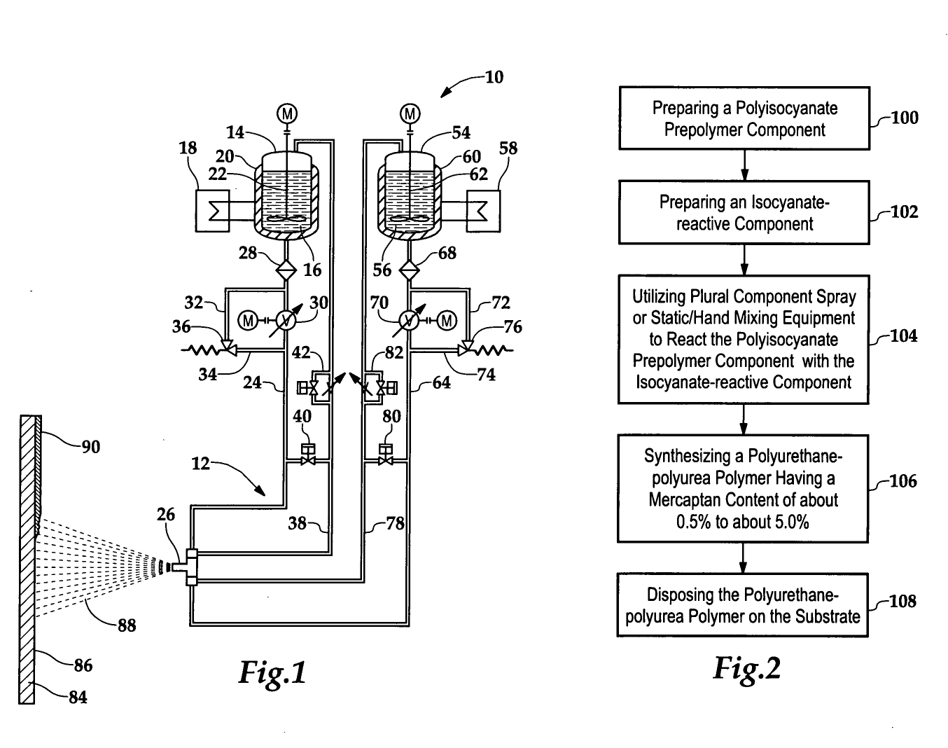

Referring initially to FIG. 1, therein is depicted a coating system that is schematically illustrated and generally designated 10. Plural component spray equipment 12 includes a chamber 14 for holding a polyisocyanate prepolymer component 16. A heater/chiller 18 utilizes a jacket 20 to heat and cool the contents of the chamber 14. A mixing element 22 operating under power of an electric motor agitates the polyisocyanate prepolymer component 16. A flowline 24 connects the chamber 14 to a mix head 26, which, in one embodiment, may be equipped with a stirring element. A heat exchanger 28 is positioned within the flowline 24 to provide further temperature control of the polyisocyanate prepolymer component 16. A metering pump 30 is coupled to the flowline 24 and operates under power of an electric motor to meter a predetermined amount of the polyisocyanate prepolymer component 16 from the chamber 14 to the mix head 26. The portion of the flowline. 24 between the metering pump 30 and the mix head 26 may be quite long; namely, up to 100 meters in some implementations. Flowlines 32 and 34 connect flowline 24 to relief valve 36 at positions upstream and downstream, respectively, of the metering pump 30. A flowline 38 connects the chamber 14 and the mix head 26 to provide for return of the polyisocyanate prepolymer component 16 from the mix head 26 to the chamber 14. A bypass 40 couples the flowlines 24 and 38 together to provide for low pressure recirculation that may be utilized to condition the polyisocyanate prepolymer component 16 after long interruptions of operation, for example. A pressure control valve 42 is connected to the flowline 38 to control fluid flow therethrough.

A chamber 54, which holds an isocyanate-reactive component 56, is analogous to the chamber 14. Similarly, elements 58-82 of the plural component spray equipment 12 are analogous to elements 18-24 and 28-42, respectively. More specifically, a heater/chiller 58, a jacket 60, and a mixing element 62 are associated with the chamber 54. A flowline 64 connects the chamber 54 to the mix head 26. A heat exchanger 68 and metering pump 70 are connected to the flowline 64. Flowlines 72 and 74 connect a relief valve 76 to the flowline 64. A flowline 78, which acts as a return flowline, connects the mix head 26 to the chamber 54. A bypass 80 provides for fluid communication between the flowlines 64 and 78. A pressure control valve 82 is connected to the flowline 78.

In operation, a high-pressure impingement mixing technique is utilized wherein the polyurethane-polyurea polymer may be formulated as an A-side, i.e., the polyisocyanate prepolymer component 16, and a B-side, i.e., the isocyanate-reactive component 56. The metering pumps 30 and 70 in conjunction with the valving of the plural component spray equipment 12 are utilized to establish the mixing ratio and injection pressure for the synthesis of the polyurethane-polyurea polymer. In one implementation, the mixing ratio between the polyisocyanate prepolymer component 16 and the isocyanate-reactive component 56 may range from 1:10 to 10:1. In particular, the ratio may be 1:1. Injection pressures between 2,000 psi and 3,000 psi may be utilized. The heater/chillers 18 and 58 and heat exchangers 28 and 68 establish the temperatures, which may be in the range of about 145° F. to about 190° F. (about 63° C. to about 88° C.) of the polyisocyanate prepolymer component 16 and the isocyanate-reactive component 56.

The mix head 26 is directed at a substrate 84 having a surface 86. In one implementation, the surface 86 is sound, dry, clean, and free of surface imperfections such as holes, cracks, and voids. Additionally, the surface 86 is free of contaminants such as oil, grease, dirt, and mildew, for example. The substrate 84 may be pretreated with an acid wash and conditioner or penetrating bonding agent, for example, prior to the application of the polyurethane-polyurea polymer. The metered amount of the polyisocyanate prepolymer component 16 and the metered amount of the isocyanate-reactive component 56 are sprayed or impinged into each other in the mix head 26. A mixed formulation 88 immediately exits the mix head 26 as a spray to form a polyurethane-polyurea polymer coating 90 that adheres to the surface 86 of the substrate 84. As will be explained in more detail hereinbelow, the polyurethane-polyurea polymer coating 90 has a mercaptan content of about 0.5% to about 5.0% and, in one implementation, the mercaptan content is about 1.2% to about 2.4%. The mercaptan moieties impart improved chemical resistance and/or impermeability to the polyurethane-polyurea polymer coating 90.

The plural component spray equipment 12 complements the rapid kinetics of the polyurethane-polyurea polymer synthesis reaction as the overall synthesis of the polyurethane-polyurea polymer coating 90 is very fast and the pot lives of successful formulations and tack free time are short compared to coating formulations that are applied as powders and then heated to melt the powders into coatings. In one implementation, the polyurethane-polyurea polymer coating gels in less than 6 seconds and is tack free in less than 11 seconds. It should be appreciated that although the coating system 10 is illustrated with reference to coating a substrate, the coating system 10 of the present invention may be employed with a mold to form a cast polyurethane-polyurea elastomer, for example. Moreover, as will be discussed in further detail hereinbelow, the polyurethane-polyurea polymer may be synthesized via static or hand mixing for use in a retarded cure application.

FIG. 2 depicts one embodiment of a method for coating a substrate with a polyurethane-polyurea polymer. The methodologies presented herein may be utilized for secondary containment membranes, corrosion control linings, or as part of a cleanup treatment, for example. The substrate may be concrete, aluminum, steel, brick, blacktop, or polyurethane foam, for example. By way of further examples, the coating schemes presented herein may be utilized to coat and protect fishing boats, geotextile fabrics, pipelines, decks, manholes, or fuel tanks, for example. Additionally, the coating schemes presented herein may be utilized to increase the mechanical resistance of a substrate.

Mercaptan functional moieties are incorporated into the polyisocyanate prepolymer component via the reactive component, the isocyanate-reactive component, or both in order to provide a mercaptan content of about 0.5% to about 5.0% in the polyurethane-polyurea polymer. The organic compound having a mercaptan functional moiety is preferably a polysulfide or polymercaptan. Most preferably, the polysulfide is a thiol having the following general formula:
R—SH
wherein R equals an aliphatic, cyclic, or aromatic organic compound having any arrangement of functional groups. Typically, the polysulfide will include two or more sulfur atoms and contain reactive mercaptan end-groups according to the following general formula:
HS—R′(SS—R″)ₙ—SH
wherein R′ and R″ are each an aliphatic, cyclic, or aromatic organic compound having any arrangement of functional groups.

Suitable polysulfides include aliphatic polysulfides (ALIPS) and polymercaptans. The formation of ALIPS occurs by way of an equilibrating polycondensation reaction from bifunctional organic compounds such as dihalogen alkanes or dihalogen ether and alkali metal polysulfide solution. Suitable ALIPS include THIOPLAST™ polysulfides manufactured by Akzo Nobel Inc. (Chicago, Ill.) and THIOKOL® polysulfides manufactured by Toray Industries, Inc. (Tokyo, Japan).

As previously discussed, polymercaptans are also suitable polysulfides. Polymercaptans are formed from aliphatic, cyclo-aliphatic, or aromatic molecular segments, which can also contain individual sulfur atoms, e.g., in the form of thioether or similar compounds, but which have no disulfide bridges and which have reactive mercaptan groups according to the general formula:
HS—RN—SH
where R equals acrylate, butadiene, butadiene acrylonitrile, or other suitable compound. In addition to the mercaptan end-groups, the polymercaptans may include hydroxyl end-groups, olefin end-groups, alkoxysilyl end-groups, or alkyl end-groups, for example.

At block 100, a polyisocyanate prepolymer component is prepared. The polyisocyanate prepolymer component comprises the reaction product of one or more polyisocyanates with a reactive component. Suitable polyisocyanates, which are compounds with two or more isocyanate groups in the molecule, include polyisocyanates having aliphatic, cycloaliphatic, or aromatic molecular backbones. Methylene-interrupted aromatic diisocyanates such as diphenylmethane diisocyanate (MDI), especially the 4,4′-isomer including alkylated analogs such as 3,3′-dimethyl-4,4′-diphenylmethane diisocyanate and polymeric methylenediphenyl diisocyanate are examples of suitable polyisocyanates. As those skilled in the art will appreciate, an excess of polyisocayante is reacted with the reactive component such that the polyisocyanate prepolymer component includes reactive NCO groups for the reaction with the isocyanate-reactive component.

The reactive component includes chain extenders and initiators that react with the NCO groups in the polyisocyanate to synthesize the polyisocyanate prepolymer component. In one embodiment, the reactive component may include organic compounds such as polyols, glycols, amine-substituted aromatics, and aliphatic amines, for example. As previously discussed, the mercaptan functional moieties may be incorporated into the reactive component. By way of example, the reactive component may include a polysulfide. By way of another example, the reactive component may include diethyltoluenediamine, a primary polyether triamine, polyoxypropylenediamine, and a polysulfide.

At block 102, an isocyanate-reactive component is prepared. Similar to the reactive component, the isocyanate-reactive component includes chain extenders and initiators that react with the NCO groups in the polyisocyanate prepolymer component to synthesize the polyurethane-polyurea polymer. Organic compounds such as polyols, glycols, amine-substituted aromatics, aliphatic amines, and combinations thereof, for example, are suitable isocyanate-reactive compounds. As previously discussed, the mercaptan functional moieties may be incorporated into the isocyanate-reactive component. By way of example, the isocyanate-reactive component may include diethyltoluenediamine, a polyol, and a polysulfide. By way of another example, the isocyanate-reactive component may include a polyaspartic ester and a polysulfide.

The polyisocyanate prepolymer component and the isocyanate-reactive component may include additives such as non-primary components, fillers, anti-aging agents, or coloring agents, for example. Moreover, in particular formulations, a catalyst such as an amine catalyst or organometallic catalyst may be utilized. Further details regarding the composition and preparation of the polyisocyanate prepolymer component and the isocyanate-reactive component may be found in the following commonly owned, co-pending patent applications: (1) “Isocyanate-reactive Component for Preparing a Polyurethane-polyurea Polymer,” filed on Nov. 3, 2004, application Ser. No. ______ (Attorney Docket No. 1006.1001), in the name of Michael S. Cork; and (2) “Polyisocyanate Prepolymer Component for Preparing a Polyurethane-polyurea Polymer,” filed on Nov. 3, 2004, application Ser. No. ______ (Attorney Docket No. 1006.1002), in the name of Michael S. Cork; both of which are hereby incorporated by reference for all purposes.

At block 104, in one embodiment, plural component spray equipment is utilized to react the polyisocyanate prepolymer component with the isocyanate-reactive component. In another embodiment, a static mixing technique that may include static or hand mixing equipment is utilized to react the polyisocyanate prepolymer component with the isocyanate-reactive component. The static or hand mixed formulation may be utilized in a retarded cure application, for example. By way of example, the static or hand mixed formulation may comprise polysulfides used in conjunction with secondary amines, such as a polyaspartate or a UNILINK™ 4200 diamine from Dorf Ketal Chemicals, LLC (Stafford, Tex.), or sterically hindered amines, such as di-(methylthio)toluenediamine (DMTDA). Additionally, polyether amines may be used in the formulation.

At block 106, the polyurethane-polyurea polymer having a mercaptan content of about 0.5% to about 5.0% is synthesized. At block 108, the polyurethane-polyurea polymer is disposed on the substrate. The polyurethane-polyurea polymer gels and becomes tack free after being disposed on the substrate.

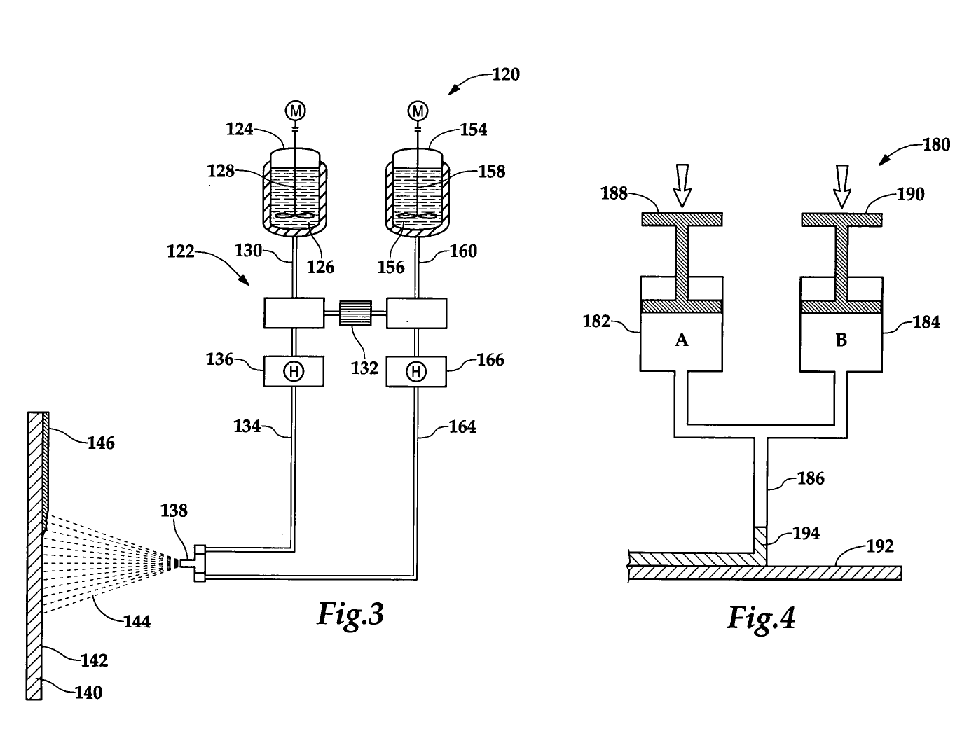

It should be appreciated that the fabrication of the polyurethane-polyurea polymer presented herein is not limited to coating techniques. The polyurethane-polyurea polymer may be shaped by pouring, molding, extrusion, or casting, for example. The molding techniques may be compression molding techniques or injection molding techniques including reaction injection molding (RIM) techniques. FIG. 3 depicts one embodiment of a system 120 for fabricating a polymer. Plural component spray equipment 122 includes a chamber 124 for holding a polyisocyanate prepolymer component 126. A mixing element 128 agitates the polyisocyanate prepolymer component 126. A flowline 130 connects the chamber 124 to a proportioner 132 which appropriately meters the polyisocayante prepolymer component 126 to a heated flowline 134 which is heated by heater 136. The heated polyisocyanate prepolymer component 126 is fed to a mix head 138.

Similarly, a chamber 154 holds an isocyanate-reactive component 156 and a mixing element 158 agitates the isocyanate-reactive component 156. A flowline 160 connects the chamber 154 to the proportioner 132 which, in turn, is connected to a heated flowline 164 having a heater 166. The heated isocyanate-reactive component 156 is provided to the mix head 138. At mix head 138, the polyisocyanate prepolymer component 126 and the isocyanate-reactive component 156 are mixed and sprayed as a mixed formulation 144 onto a substrate 140 having a surface 142 such that the mixed formulation 144 cures as a polyurethane-polyurea polymer coating 146.

FIG. 4 depicts another embodiment of a system 180 for fabricating a polymer. As illustrated, a static formulation is being utilized in a caulk application. A chamber 182 holds a polyisocyanate component and a chamber 184 holds an isocyanate-reactive component. These components are mixed in tubing 186 by the application of pressure on actuators 188 and 190 such that a substrate 192 receives a polyurethane-polyurea polymer 194.

The present invention will now be illustrated by reference to the following non-limiting working examples wherein procedures and materials are solely representative of those which can be employed, and are not exhaustive of those available and operative. Examples I-IX and the accompanying Test Methods illustrate examples of integrating mercaptan functional groups into a polyurethane-polyurea polymer. In particular, Examples I-VII and the accompanying Test Methods illustrate examples of incorporating the mercaptan functional groups into the polyurethane-polyurea polymer via the isocyanate-reactive component synthesis route discussed in detail hereinabove. Example VIII and the accompanying Test Methods illustrate an example of incorporating the mercaptan functional groups into the polyurethane-polyurea polymer via the polyisocyanate prepolymer component synthesis route discussed in detail hereinabove. Example IX and the accompanying Test Methods illustrate an incorporation via both the polyisocyanate prepolymer component and isocyanate-reactive component synthesis routes. The following glossary enumerates the components utilized in the Examples and Test Methods presented hereinbelow.

CAPA® 3091 polyol is a 900 g/mol molecular weight caprolactone polyol from Solvay S.A. (Brussels, Belgium).

Castor oil is derived from the seeds of the castor bean, Ricinus communis, and is readily available.

DESMODUR® Z 4470 BA IPDI is an IPDI trimer from Bayer Corporation (Pittsburgh, Pa.).

ETHACURE® 100 curing agent is diethyltoluenediamine (DETA) from Albemarle Corporation (Baton Rouge, La.).

ETHACURE® 300 curing agent is di-(methylthio) toluenediamine (DMTDA) from Albermarle Corporation (Baton Rouge, La.).

GLYMO™ silane is 3-glycidoxypropyl trimethoxysilane from Degussa AG (Frankfort, Germany).

JEFFAMINE® D-2000 polyoxypropylenediamine is a difunctional primary amine having an average molecular weight of 2000 g/mol from Huntsman LLC (Salt Lake City, Utah).

JEFFAMINE® T-5000 polyol is a primary polyether triamine of approximately 5000 g/mol molecular weight from Huntsman LLC (Salt Lake City, Utah).

JEFFCAT® ZF-10 amine catalyst is N,N,N′-trimethyl-N′-hydroxyethyl-bisaminoethylether from Huntsman LLC (Salt Lake City, Utah).

JEFFLINK® 754 diamine is a bis(secondary amine) cycloaliphatic diamine from Huntsman LLC (Salt Lake City, Utah).

JEFFOX® PPG-230 glycol is a 230 g/mol molecular weight polyoxyalkylene glycol from Huntsman LLC (Salt Lake City, Utah).

JEFFSOL® propylene carbonate is a propylene carbonate from Huntsman LLC (Salt Lake City, Utah).

JP-7 Fuel Oil is jet propellant-7 fuel oil manufactured in accordance with the MIL-DTL-38219 specification from special blending stocks to produce a very clean hydrocarbon mixture that is low in aromatics and nearly void of sulfur, nitrogen, and oxygen impurities found in other fuels.

K-KAT® XC-6212 organometallic catalyst is a zirconium complex reactive diluent from King Industries, Inc. (Norwalk, Conn.).

METACURE® T-12 catalyst is a dibutyltin dilaurate catalyst from Air Products and Chemicals, Inc. (Allentown, Pa.).

MONDUR® ML MDI is an isomer mixture of MDI from Bayer Corporation (Pittsburgh, Pa.) that contains a high percentage of the 2′4 MDI isomer.

POLY-T® 309 polyol is a 900 g/mol molecular weight tri-functional polycaprolactone from Arch Chemicals, Inc. (Norwalk, Conn.).

PPG-2000™ polymer is a 2000 g/mol molecular weight polymer of propylene oxide from The Dow Chemical Company (Midland, Mich.).

RUBINATE® M MDI is a polymeric MDI from Huntsman LLC (Salt Lake City, Utah) which is prepared by the phosgenation of mixed aromatic amines obtained from the condensation of aniline with formaldehyde.

THIOPLAST™ G4 polysulfide is a less than 1000 g/mol molecular weight polysulfide from Akzo Nobel Inc. (Chicago, Ill.).

THIOPLAST™ G22 polysulfide is a 2400-3100 g/mol molecular weight polysulfide from Akzo Nobel Inc. (Chicago, Ill.).

TOLONATE® HDT-LV2 isocyanate is a tri-functional 1,6-hexamethylene diisocyanate-based polyisocyanate from Rhodia Inc. (Cranbury, N.J.).

TMXDI™ isocyanate is tetramethylenexylene diisocyanate from Cytec Industries, Inc. (West Paterson, N.J.).

UNILINK™ 4200 diamine is a 310 g/mol molecular weight 2-functional aromatic diamine from Dorf Ketal Chemicals, LLC (Stafford, Tex.) (formerly from UOP Molecular Sieves (Des Plaines, Ill.)).

### Example I

An A-side prepolymer is made by reacting 2010 g of DESMODUR® Z 4470 BA IPDI with 900 g of POLY-T® 309 polyol and 160 g of TMXDI™ isocyanate. The ingredients are mixed vigorously for 5 minutes at a speed that is short of forming a vortex. Two grams of METACURE® T-12 catalyst are added and the ingredients are mixed for 3.5 hours under a blanket of inert nitrogen gas (N₂). A blanket of argon gas (Ar) or mild vacuum conditions are also suitable. It should be noted that 140° F. (60° C.) of heat may be substituted for the tin (Sn) catalyst. The A-side prepolymer formation is then complete. To the resulting A-side prepolymer, 250 g of JEFFSOL® propylene carbonate, which acts as a diluent, and 400 g of TOLONATE™ HDT-LV2 isocyanate are added. The ingredients are mixed for 1 hour and the A-side formation is complete.

A B-side resin is formed by mixing 1295 g of JEFFLINK® 754 diamine with 740 g of THIOPLAST™ G22 polysulfide and 1665 g of THIOPLAST™ G4 polysulfide. The ingredients are stirred at ambient conditions until well mixed. A tertiary type amine catalyst may be utilized to increase the rate of the reaction. The B-side resin formation is then complete. The A-Side and the B-side are then loaded into a GX-7 spray gun, which is manufactured by Gusmer Corporation (Lakewood, NJ), and impinged into each other at a 1:1 ratio at 2500 psi and 170° F. (77° C.). The resulting polymer gels in approximately 6 seconds and is tack free in approximately 11 seconds.

### Example II

The polyurethane-polyurea polymer was prepared substantially according to the procedures presented in Example I with the components noted in Table VII.

TABLE VII
Polymer Formation (Example II)

| A-side | B-side |
|---|---|
| 66% by wt of MONDUR ® ML MDI | 13% by wt of ETHACURE ® |
| | 100 curing agent |
| 3% by wt of RUBINATE ® M MDI | 5% by wt of ETHACURE ® |
| | 300 curing agent |
| 25% by wt of POLY-T ® 309 polyol | 19% by wt of UNILINK ™ |
| | 4200 diamine |
| 4% by wt of GLYMO ™ silane | 33% by wt of THIOPLAST ™ |
| | G22 polysulfide |
| 2% by wt of additives (e.g., color | 30% by wt of THIOPLAST ™ |
| control additives) | G4 polysulfide |

### Example III

The polyurethane-polyurea polymer was prepared substantially according to the procedures presented in Example I with the components noted in Table VIII.

TABLE VIII
Polymer Formation (Example III)

| A-side | B-side |
|---|---|
| 52.5% by wt of MONDUR ® ML | 10% by wt of ETHACURE ® |
| MDI | 100 curing agent |
| 2.25% by wt of RUBINATE ® M | 26% by wt of UNILINK ™ |
| MDI | 4200 diamine |
| 20.25% by wt of POLY-T ® 309 | 34% by wt of THIOPLAST ™ |
| polyol (CAPA ® 3091 polyol is a | G22 polysulfide |
| suitable alternative) | |
| 45% by wt of TOLONATE ® HDT- | 30% by wt of THIOPLAST ™ |
| LV2 isocyanate | G4 polysulfide |

### Example IV

The polyurethane-polyurea polymer was prepared substantially according to the procedures presented in Example I with the components noted in Table IX.

TABLE IX
Polymer Formation (Example IV)

| A-side | B-side |
|---|---|
| 70.5% by wt of MONDUR ® ML MDI | 35% by wt of JEFFOX ® |
| | PPG-230 glycol |
| 26% by wt of POLY-T ® 309 polyol | 25% by wt of THIOPLAST ™ |
| | G22 polysulfide |
| 3.5% JEFFSOL ® propylene | 40% by wt of THIOPLAST ™ |
| carbonate | G4 polysulfide |

### Example V

The polyurethane-polyurea polymer was prepared substantially according to the procedures presented in Example I with the components noted in Table X.

TABLE X
Polymer Formation (Example V)

| A-side | B-side |
|---|---|
| 66.5% by wt of MONDUR ® ML | 25% by wt of ETHACURE ® |
| MDI | 100 curing agent |
| 16.75% by wt of PPG-2000 ™ polymer | 65% by wt of THIOPLAST ™ |
| | G4 polysulfide |
| 16.75% by wt of Castor oil | 10% by wt of JEFFAMINE ® |
| | T-5000 polyol |

### Example VI

The polyurethane-polyurea polymer was prepared substantially according to the procedures presented in Example I with the components noted in Table XI.

TABLE XI
Polymer Formation (Example VI)

| A-side | B-side |
|---|---|
| 77% by wt of MONDUR ® ML MDI | 13.5% by wt of ETHACURE ® |
| | 100 curing agent |
| 23% by wt of Castor oil | 70.5% by wt of THIOPLAST ™ |
| | G4 polysulfide |
| | 16% by wt of UNILINK ™ |
| | 4200 diamine |

### Example VII

The polyurethane-polyurea polymer was prepared substantially according to the procedures presented in Example I with the components noted in Table XII.

TABLE XII
Polymer Formation (Example VII)

| A-side | B-side |
|---|---|
| 70% by wt of MONDUR ® ML MDI | 13.5% by wt of ETHACURE ® |
| | 100 curing agent |
| 4% by wt of RUBINATE ® M MDI | 70.5% by wt of THIOPLAST ™ |
| | G4 polysulfide |
| 26% by wt of POLY-T ® 309 polyol | 16% by wt of UNILINK ™ |
| | 4200 diamine |

### Example VIII

The polyurethane-polyurea polymer was prepared substantially according to the procedures presented in Example I with the components noted in Table XIII.

TABLE XIII
Polymer Formation (Example VIII)

| A-side | B-side |
|---|---|
| 70% by wt of MONDUR ® ML MDI | 25% by wt of ETHACURE ® |
| | 100 curing agent |
| 4% by wt of RUBINATE ® M MDI | 4% by wt of JEFFAMINE ® |
| | T-5000 polyol |
| 25% by wt of THIOPLAST ™ G4 | 71% by wt of JEFFAMINE ® |
| polysulfide | D-2000 |
| | polyoxypropylenediamine |
| <1% by wt of JEFFCAT ® ZF-10 amine | |
| catalyst | |
| <1% by wt of K-KAT ® XC-6212 | |
| organometallic catalyst | |

### Example IX

The polyurethane-polyurea polymer was prepared substantially according to the procedures presented in Example I with the components noted in Table XIV.

TABLE XIV
Polymer Formation (Example IX)

| A-side | B-side |
|---|---|
| 70% by wt of MONDUR ® ML MDI | 13% by wt of ETHACURE ® |
| | 100 curing agent |
| 4% by wt of RUBINATE ® M MDI | 19% by wt of UNILINK ™ |
| | 4200 diamine |
| 25% by wt of THIOPLAST ™ G4 | 30% by wt of THIOPLAST ™ |
| polysulfide | G22 polysulfide |
| <1% by wt of JEFFCAT ® ZF-10 | 38% by wt of THIOPLAST ™ |
| amine catalyst | G4 polysulfide |
| <1% by wt of K-KAT ® XC-6212 | |
| organometallic catalyst | |

The following tables, Tables XV-XVII, provide a survey of the mercaptan content of the polymers synthesized in accordance with Examples I-IX.

TABLE XV
Mercaptan Content

| Polymer Example | I | II | III |
|---|---|---|---|
| Mercaptan Content (%) | 1.3-2.2 | 1.2-1.9 | 1.2-2.0 |

TABLE XVI
Mercaptan Content

| Polymer Example | IV | V | VI |
|---|---|---|---|
| Mercaptan Content (%) | 1.4-2.3 | 1.9-3.3 | 2.1-3.5 |

TABLE XVII
Mercaptan Content

| | Polymer Example | | |
|---|---|---|---|
| | VII | VIII | IX |
| Mercaptan Content (%) | 2.1-3.5 | 0.7-1.3 | 2.2-3.6 |

The foregoing Examples I-IX of the present invention were tested against a high-tensile strength standard polyurea (HTS-SP) of conventional preparation having components noted in Table XVIII.

TABLE XVIII
Formation of HTS-SP

| A-side | B-side |
|---|---|
| 60% by wt of MONDUR ® | 25% by wt of ETHACURE ® 100 curing |
| ML MDI | agent |
| 40% by wt of PPG-2000 ™ | 10% by wt of JEFFAMINE ® T-5000 |
| polymer | polyol |
| | 70% by wt of JEFFAMINE ® D-2000 |
| | polyoxypropylenediamine |

Test Method I. A polyurethane-polyurea polymer of the present invention synthesized in accordance with Example V (Ex. V Polymer) and the HTS-SP were tested according to the standard test method for tensile properties of plastics prescribed in American Society for Testing and Materials (ASTM) D638. This test method covers the determination of the tensile properties of unreinforced and reinforced plastics in the form of standard dumbbell-shaped test specimens when tested under defined conditions of pretreatment, temperature, humidity, and testing machine speed. Table XIX depicts the ASTM D638 test results for the Ex. V Polymer and the HTS-SP.

TABLE XIX
ASTM D638 Test Results

| | Mean Yield | Mean Maximum | Mean Young's |
|---|---|---|---|
| Polymer | Stress (psi) | Strain (%) | Modulus (psi) |
| Ex. V Polymer | 2,419 | 110 | 28,414 |
| HTS-SP | 1,024 | 561 | 10,768 |

Test Method II. The Ex. V Polymer and the HTS-SP were tested according to the standard test method for water transmission of materials prescribed in ASTM E96. This test method covers the determination of water vapor transmission of materials through which the passage of water vapor may be of importance. Table XX depicts the ASTM E96 test results for the Ex. V Polymer and the HTS-SP.

TABLE XX
ASTM E96 Test Results

| | Mean Permeance | Mean Average |
|---|---|---|
| Polymer | (perms) | Permeability (perms-in) |
| Ex. V Polymer | 0.204 | 0.007 |
| HTS-SP | 1.632 | 0.066 |

Test Method III. The Ex. V Polymer and the HTS-SP were tested according to the standard test method for tear strength of conventional vulcanized rubber and thermoplastic elastomers prescribed in ASTM D624. This test method describes procedures for measuring a property of conventional vulcanized thermoset rubber and thermoplastic elastomers called tear strength. Table XXI depicts the ASTM D624 test results for the Ex. V Polymer and the HTS-SP.

TABLE XXI
ASTM D624 Test Results

| Polymer | Maximum Load (lbs) | Tear PLI (lbs/lin in) |
|---|---|---|
| Ex. V Polymer | 15.47 | 449.6 |
| HTS-SP | 16.13 | 476.2 |

Testing Method IV. A polyurethane-polyurea polymer of the present invention synthesized in accordance with Example III (Ex. III Polymer), the HTS-SP, and a conventional polyurea were tested to evaluate resistance to chemical reagents and, in particular, resistance to gasoline, xylene, and diesel fuel. Each of polymers under evaluation was sealed in a glass receptacle containing one of the three test fluids for 30 days at ambient conditions. At the end of the 30 days, change in weight was recorded. Table XXII depicts the Chemical Resistance test results, i.e., percent weight increase, for the Ex. III Polymer, the HTS-SP, and the conventional polyurea (CP).

TABLE XXII
Chemical Resistance Test Results

| | Gasoline | Xylene | Diesel Fuel |
|---|---|---|---|
| Polymer | (% wt inc.) | (% wt inc.) | (% wt inc.) |
| Ex. III Polymer | 1.4 | 8.7 | 0.7 |
| HTS-SP | 26.3 | 37.1 | 10.9 |
| CP | 69.1 | 110.3 | 21.4 |

After 30 days, the test fluid in each of the three receptacles housing the Ex. III Polymer was exchanged out and the testing continued. After a total of 120 days, weight increases of the Ex. III Polymer were 4.8%, 11.6%, and 1.4% for gasoline, xylene, and diesel fuel, respectively. Additionally, the Ex. I-II and IV-IX Polymers exhibited chemical resistance with respect to gasoline, xylene, and diesel fuel substantially equivalent to the Ex. III Polymer.

Testing Method V. A polyurethane-polyurea polymer of the present invention synthesized in accordance with Example IX (Ex. IX Polymer) was tested to evaluate resistance to chemical reagents and, in particular, resistance to a mixture of JP-7 Jet Fuel Oil and toluene. The Ex. IX Polymer under evaluation was sealed in a glass receptacle containing 30% JP-7 Jet Fuel Oil and 70% toluene. Periodically changes in weight and dimension were recorded. Table XXIII depicts the Chemical Resistance test results, i.e., percent weight increase and percent dimension increase, for the Ex. IX Polymer.

TABLE XXIII
Chemical Resistance Test Results

| | Weight Increase | Dimension Increase |
|---|---|---|
| TIME | (% wt inc.) | (% dim inc.) |
| 24 hours | 1.6% | <0.5% |
| 72 hours | 2.7% | <0.5% |
| 96 hours | 3.2% | <0.5% |
| 120 hours | 3.4% | <0.5% |

Moreover, the Ex. I-VIII Polymers exhibited jet fuel oil/toluene resistance substantially equivalent to the Ex. IX Polymer. The results of Testing Methods I-V illustrate that the polyurethane-polyurea polymers having the mercaptan functional moieties in accordance with the teachings presented herein exhibit physical properties that are equivalent or better than those of existing polyurethane-polyurea polymers, thereby enabling the polyurethane-polyurea polymers presented herein to provide surface protection to a substrate. Further, the polyurethane-polyurea polymers synthesized according to the teachings presented herein exhibit chemical resistance at least an order of magnitude better than existing polyurethane-polyurea polymers.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A polymer system comprising:
a substrate having a surface; and
a polyurethane-polyurea polymer disposed on the surface, the polyurethane-polyurea polymer having a mercaptan content of about 0.5% to about 5.0% and being the reaction product of a polyisocyanate prepolymer component and an isocyanate-reactive component.

2. The polymer system as recited in claim 1, wherein the substrate comprises a material selected from the group consisting of concrete, aluminum, steel, blacktop, and polyurethane foam.

3. The polymer system as recited in claim 1, wherein the substrate comprises a material selected from the group consisting of boat holds, geotextile fabrics, pipelines, decks, manholes, and fuel tanks.

4. The polymer system as recited in claim 1, wherein the mercaptan content further comprises about 1.2% to about 2.4%.

5. The polymer system as recited in claim 1, wherein the polyisocyanate prepolymer component contributes to the mercaptan content of the polyurethane-polyurea polymer.

6. The polymer system as recited in claim 1, wherein the isocyanate-reactive component contributes to the mercaptan content of the polyurethane-polyurea polymer.

7. The polymer system as recited in claim 1, wherein the polyisocyanate prepolymer component and the isocyanate-reactive component contribute to the mercaptan content of the polyurethane-polyurea polymer.

8. The polymer system as recited in claim 1, wherein the polyurethane-polyurea polymer is disposed on the surface using plural component spray equipment.

9. The polymer system as recited in claim 1, wherein the polyisocyanate prepolymer component and the isocyanate-reactive component are reacted using a high-pressure impingement mixing technique.

10. The polymer system as recited in claim 1, wherein the polyisocyanate prepolymer component and the isocyanate-reactive component are reacted using a technique selected from the group consisting of static mixing techniques and hand-mixing techniques.

11. The polymer system as recited in claim 1, wherein the polyisocyanate prepolymer component and the isocyanate-reactive component are reacted using a technique selected from the group consisting of spraying techniques, pouring techniques, molding techniques, extrusion techniques, and casting techniques.

12. The polymer system as recited claim 1, wherein the polyisocyanate prepolymer component and the isocyanate-reactive component are reacted at a temperature in the range of about 145° F. to about 190° F.

13. The polymer system as recited in claim 1, wherein the polyisocyanate prepolymer component and the isocyanate-reactive component are reacted at a ratio in a range of 1:10 to 10:1.

14. The polymer system as recited in claim 1, wherein the polyisocyanate prepolymer component and the isocyanate-reactive component are reacted at a ratio of 1:1.

15. The polymer system as recited in claim 1, wherein the polyisocyanate prepolymer component comprises diphenylmethane diisocyanate.

16. The polymer system as recited in claim 1, wherein the isocyanate-reactive component comprises a polysulfide.

17. The polymer system as recited in claim 1, wherein the isocyanate-reactive component comprises an organic compound selected from the group consisting of amine-substituted aromatics, aliphatic amines, and glycols.

18. A method for coating a substrate, the method comprising:
preparing a polyisocyanate prepolymer component;
preparing an isocyanate-reactive component;
utilizing plural component spray equipment to react the polyisocyanate prepolymer component with the isocyanate-reactive component;
synthesizing a polyurethane-polyurea polymer having a mercaptan content of about 0.5% to about 5.0%; and
disposing the polyurethane-polyurea polymer on the substrate.

19. The method as recited in claim 18, wherein the polyisocyanate prepolymer component contributes to the mercaptan content of the polyurethane-polyurea polymer.

20. The method as recited in claim 18, wherein the isocyanate-reactive component contributes to the mercaptan content of the polyurethane-polyurea polymer.

21. The method as recited in claim 18, wherein the polyisocyanate prepolymer component and the isocyanate-reactive component contribute to the mercaptan content of the polyurethane-polyurea polymer.

22. The method as recited in claim 18, further comprising heating the polyisocyanate prepolymer component and the isocyanate-reactive component to a temperature in a range of about 145° F. to about 190° F.

23. The method as recited in claim 18, wherein utilizing plural component spray equipment to react the polyisocyanate prepolymer component with the isocyanate-reactive component further comprises mixing the polyisocyanate prepolymer component with the isocyanate-reactive component at a ratio in a range of 1:10 to 10:1.

24. A system for coating a substrate, the system comprising:
means for holding a polyisocyanate prepolymer component;
means for holding an isocyanate-reactive component;
means for reacting the polyisocyanate prepolymer component with the isocyanate-reactive component to synthesize a polyurethane-polyurea polymer having a mercaptan content of about 0.5% to about 5.0%; and
means for disposing the polyurethane-polyurea polymer on the substrate.

25. The system as recited in claim 24, wherein the polyisocyanate prepolymer component contributes to the mercaptan content of the polyurethane-polyurea polymer.

26. The system as recited in claim 24, wherein the isocyanate-reactive component contributes to the mercaptan content of the polyurethane-polyurea polymer.

27. The system as recited in claim 24, wherein the polyisocyanate prepolymer component and the isocyanate-reactive component contribute to the mercaptan content of the polyurethane-polyurea polymer.

28. The system as recited in claim 24, further comprising means for heating the polyisocyanate prepolymer component and the isocyanate-reactive component to a temperature in a range of about 145° F. to about 190° F.

29. The system as recited in claim 24, wherein the means for utilizing plural component spray equipment to react the polyisocyanate prepolymer component with the isocyanate-reactive component further comprises means for mixing the polyisocyanate prepolymer component with the isocyanate-reactive component at a ratio in a range of 1:10 to 10:1.

30. A method for coating a substrate, the method comprising:
preparing a polyisocyanate prepolymer component;
preparing an isocyanate-reactive component;
utilizing a static mixing technique to react the polyisocyanate prepolymer component with the isocyanate-reactive component;
synthesizing a polyurethane-polyurea polymer having a mercaptan content of about 0.5% to about 5.0%; and
disposing the polyurethane-polyurea polymer on the substrate.

31. The method as recited in claim 30, wherein the polyisocyanate prepolymer component contributes to the mercaptan content of the polyurethane-polyurea polymer.

32. The method as recited in claim 30, wherein the isocyanate-reactive component contributes to the mercaptan content of the polyurethane-polyurea polymer.

33. The method as recited in claim 30, wherein the polyisocyanate prepolymer component and the isocyanate-reactive component contribute to the mercaptan content of the polyurethane-polyurea polymer.
